(19) United States
(12) Patent Application Publication
(10) Pub. No.: US 2008/0074479 A1
(43) Pub. Date: Mar. 27, 2008

(54) Method and apparatus for filling ink-jet cartridge

(75) Inventors: Abelardo Santos, Havre De Grace, MD (US); Michael D. Warner, Colorado Springs, CO (US); Michael J. Arkowski, Colorado Springs, CO (US); Ricardo Gomez, Colorado Springs, CO (US)

Correspondence Address: LINDA FLEWELLEN GOULD, 1665 BRIARGATE BLVD. #101, COLORADO SPRINGS, CO, 80920, US

(73) Assignee: Tri-Century Corporation

(21) Appl. No.: 11/528,005

(22) Filed: Sep. 27, 2006

(51) Int. Cl. B41J 2/175

(52) U.S. Cl. 347/85

(57) ABSTRACT

The present invention provides a method and an apparatus for filling ink-jet cartridges with ink. Ink-jet cartridges are commonly refilled with ink while under a vacuum, to facilitate completely filling a reservoir or foam insert within the cartridge. However, when the cartridge is subsequently submitted to atmospheric pressure, a significant amount of ink is suctioned out of the cartridge, creating a mess and leaving the cartridge less than full. The instant invention results in a fully refilled ink cartridge, without leaking ink, by timed release of the vacuum during the ink filling process.

### BACKGROUND OF THE INVENTION

1. Field of the Invention

The present invention relates generally to a method of and apparatus for filling ink-jet type ink cartridges.

2. Description of the Prior Art

Ink-jet cartridges are commonly refilled with ink to enable the cartridge to be recycled for further use, rather than being disposed of and replaced at an additional expense. A number of methods of refilling ink cartridges are known in the prior art. Some of these methods involve placing the cartridge in a vacuum chamber where it is submitted to lower than atmospheric pressure, thereby eliminating air from the interior of the cartridge and expanding and opening the pores of a foam or sponge inside the cartridge. Ink can then be pumped into the cartridge through one or more hoses leading from a supply of ink outside the vacuum chamber, or may be introduced into the cartridge by one or more syringes. Although single color ink cartridges can be refilled with a single hose or syringe, multi-color cartridges require multiple hoses or syringes, allowing separate reservoirs within the cartridge to be filled with cyan, magenta, yellow, and black ink, or some other combination of possible colored inks.

Each color reservoir within an ink-jet type cartridge typically contains foam or a sponge, suitable for soaking and storing ink. Each reservoir is capable of holding more ink, while subjected to a vacuum, than when the cartridge is at atmospheric pressure. Thus, submitting the cartridge to a vacuum facilitates refilling the cartridge with ink, but commonly results in some of the ink leaking out of the cartridge when the cartridge is returned to atmospheric pressure. This creates a significant disadvantage of refilled cartridges when compared to cartridges that have been filled in the process of making the cartridge, and thus an impediment to recycling ink-jet cartridges. A refilled cartridge typically has an amount of ink which is less than capacity, and potentially less than a new cartridge, since some of the ink leaked out of the cartridge in the refilling process. Furthermore, the recycled cartridge may be messy to utilize, as a result of leaked ink on the exterior of the cartridge.

Examples of cartridge refilling methods known in the prior art include U.S. Pat. No. 6,733,115 to Santhanam et al., and a related pending application 2002/0196317. In the process taught in those documents, a vacuum is applied to the nozzle array of the print head nozzle during the procedure of filling the cartridge. Similarly, U.S. Pat. No. 5,801,735 to Lorenze, Jr. et al., requires a pressure gradient between a refill ink container and print head nozzles during refilling. U.S. Pat. No. 6,116,719 to Maza teaches an ink replenishment system in which vacuum pressure is used to move ink from a reservoir into a pen cartridge.

U.S. Pat. No. 5,459,497 to Manning et al. describes a process in which a pump is used to pressurize ink and air during a refilling process. Similarly, U.S. Pat. No. 6,796,627 to Kimura et al. requires pressurization of air and ink during refilling and U.S. Patent Application 2005/0024423 requires a positive-pressure supply to apply positive pressure on ink. The refilling device of U.S. Patent Application 2005/0243150 requires ink to be supplied under pressure to fill a cartridge chamber.

U.S. Pat. No. 7,008,038 to Takagi et al. and related application 2004/0075710 teach a cartridge refilling process which is accomplished through the print head of the cartridge. European Patent Application EP 1661710A2 describes a cartridge refilling process in which liquid is injected through an air discharge opening made open in an injection hole film piercing process.

The difficulty in completely filling an ink jet cartridge is discussed in U.S. Patent Application 2002/0012032. This patent application proposes a specialized cartridge including a penetrable diaphragm to alleviate the problem.

The invention described herein is a device and process enabling typical ink-jet type cartridges to be completely filled with ink, without loosing ink when the cartridge is removed from a vacuum chamber and returned to atmospheric pressure. As a result, the process avoids the mess created by many refilling processes, and results in the maximum possible amount of ink being available for use in the recycled cartridge.

### SUMMARY AND OBJECTS OF THE INVENTION

A primary object of the present invention is to provide a method and process for refilling ink-jet type cartridges to provide a maximum amount of ink in the recycled cartridge.

Another object of the present invention is to refill an ink-jet cartridge in a manner that prevents ink from spontaneously leaking out of the cartridge.

These objects are achieved by removing air from an ink-jet type cartridge to create a vacuum, pumping ink through an ink filling pathway leading into the cartridge, and then releasing the vacuum by infusing air into the cartridge while ink is being pumped into the cartridge. While ink is commonly delivered into an ink-jet cartridge while the cartridge is under a vacuum, processes known in the prior art typically do not release the vacuum until after the ink filling process has been completed. By releasing the vacuum at a desirable time during the filling process, over-filling of the cartridge is avoided, and ink is not pushed out of the cartridge when the cartridge is returned to atmospheric pressure after filling.

The device used in the claimed process of refilling ink-jet type cartridges includes a vacuum chamber in which the cartridge can be secured. A clip suitable for holding a cartridge in place may be fastened to the interior floor or wall of the vacuum chamber, or the interior cavity of the vacuum chamber may be shaped and sized so as to securely hold a cartridge of a particular type when that cartridge is placed in the chamber. Ink filling pathways, such as hoses or syringes, can be inserted through holes in the wall of the vacuum chamber, in sealed fashion allowing a vacuum to be maintained within the chamber. These pathways provide a conduit for ink from a reservoir of ink on the outside of the chamber, into the cartridge placed in the vacuum chamber. Each pathway can beneficially be fitted with a flow restriction valve which allows ink to flow only in the direction of the cartridge, and only when a desired pressure is applied to ink in the ink reservoir. Pressure can be applied to the ink through a typical pump or by mechanically pushing a plunger in a syringe-type drive device

Once the cartridge is secured within the vacuum chamber, air is evacuated from the chamber to create a vacuum within the chamber. Air is thus removed from the cartridge, allowing the pores of foam within the cartridge to expand and open, enabling more ink to be received than when the foam was at atmospheric pressure. While the pressure within the chamber and the cartridge is lower than atmospheric pressure, ink is pushed into the ink filling pathway, and ultimately into the cartridge. By sealing the print head of the cartridge prior to placement in the chamber, ink can be pushed into the cartridge without leaking through the print head, in a manner that allows the print head to be primed as the cartridge is filled to capacity.

In a preferred embodiment of the present invention, the vacuum within the chamber is released while the ink is being pumped into the cartridge, prior to the cartridge being filled to capacity. A timer may be utilized to initiate the infusion of air into the vacuum chamber, and thus into the cartridge within the chamber, at a desired time after ink has started filling the cartridge. Ink quickly begins to fill the cartridge while it is at less than atmospheric pressure, allowing the print head to be primed. However, the ink level is kept lower as it reaches capacity and this level is influenced when the vacuum chamber is returned to atmospheric pressure. As a result, the cartridge is completely filled, and ink is not pushed out of the cartridge as typically results from returning the cartridge to room pressure after the filling operation is complete.

### BRIEF DESCRIPTION OF THE DRAWINGS

FIG. 1 is a perspective view of a device for filling an ink-jet type cartridge, with the vacuum chamber and inkjet cartridge cutaway to reveal the interior thereof, according to the present invention.

FIG. 2 is a perspective view of an open device for filling a particular size and shape ink-jet type cartridge, with the vacuum chamber cutaway to reaveal the interior thereof, according to the present invention.

FIG. 3 is a perspective view of a device for filling an ink-jet type cartridge utilizing syringes to fill multiple ink reservoirs, with the vacuum chamber and inkjet cartridge cutaway to reveal the interior thereof, according to the present invention.

FIG. 4 is a perspective view of an ink-jet type cartridge, cutaway to reveal multiple ink reservoirs.

FIG. 5 is a cutaway view of the interior of an ink dispensing syringe.

### DESCRIPTION OF THE PREFERRED EMBODIMENT

The present invention concerns a method and apparatus for refilling ink-jet type cartridges in a manner that allows the cartridges to be completely filled with ink and which avoids leaking of ink after the refilling process is completed. In the following description, numerous specific details are set forth in order to provide a thorough understanding of the present invention. It will be obvious, however, to one skilled in the art that the present invention may be practiced without these specific details. Some well-known methods and structures have not been set forth in order not to unnecessarily obscure the description of the present invention.

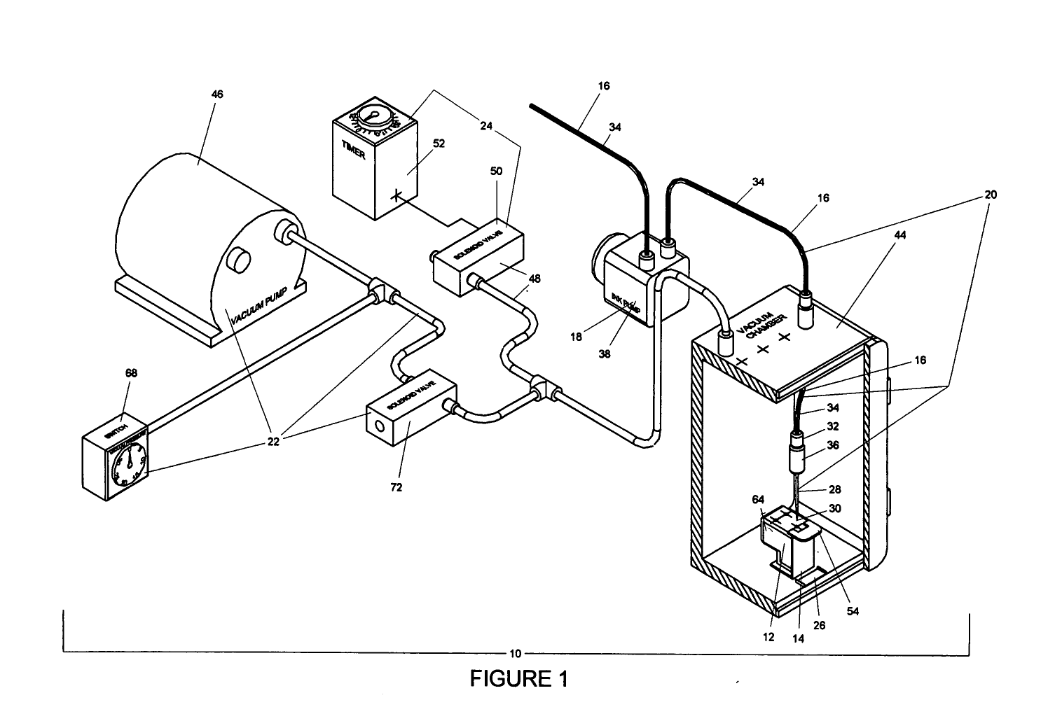

As can be seen in FIG. 1, the ink filling device 10 claimed herein includes an ink pumping means 18, at least one ink filling pathway 20, a vacuum creating means 22, and a timed vacuum releasing means 24. An ink-jet type cartridge 12 typically has an extension which serves as a print head 14, and a foam 64 inside the cartridge suitable for absorbing ink 16. It is desirable to seal the print head 14 with a closure means 26 to prevent air from migrating toward the print head 14, which could create an air bubble between ink 16 and the print head 14. The closure means 26 can be as simple as a piece of removable tape placed over the openings in the print head 14 while the cartridge 12 is being filled.

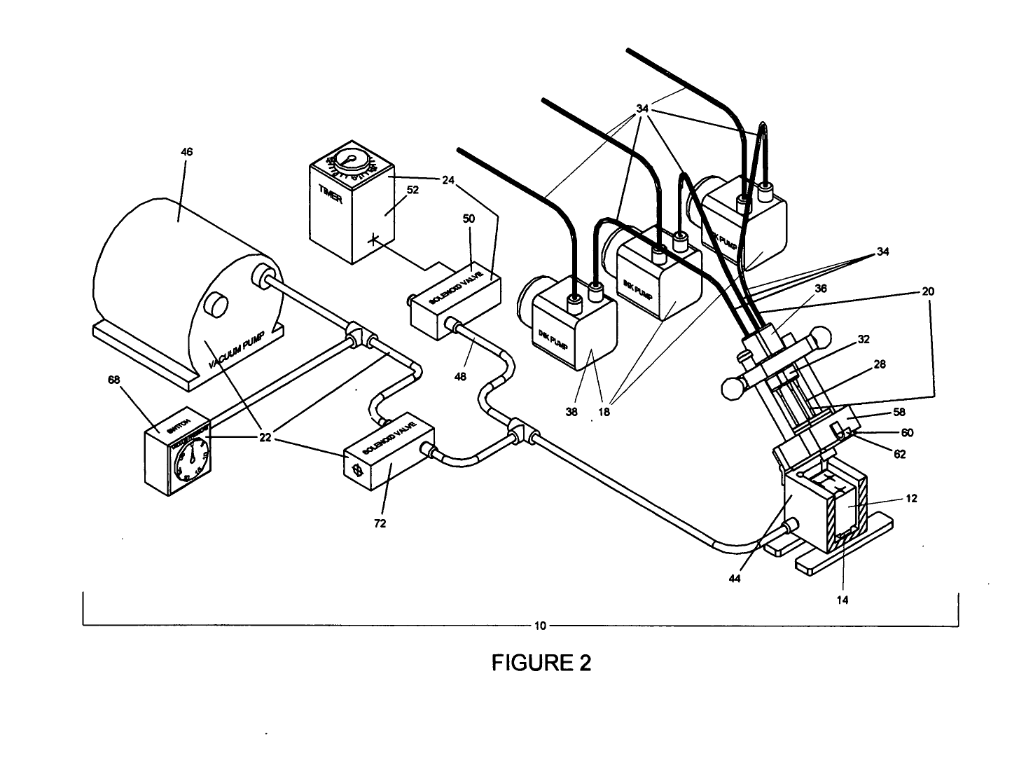

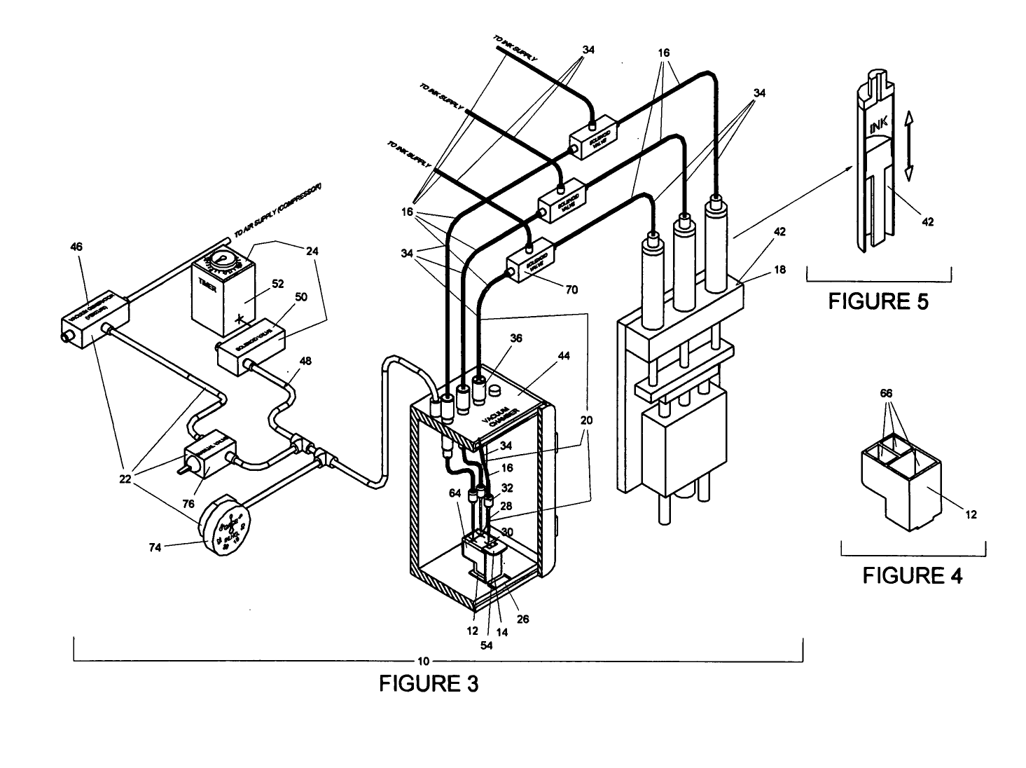

The cartridge 12 can be securely placed in the device 10 by a number of mechanisms. For example, the vacuum creating means 22 may include a vacuum chamber 44 with an interior sized and shaped to snugly receive a particular type of ink-jet cartridge 12, as shown in FIG. 2. Alternatively, a more universally shaped and sized vacuum chamber 44 may be utilized, as shown in FIGS. 1 and 3, equipped with a cartridge cradle or clip 54 into which the cartridge 12 is inserted, which holds the cartridge 12 in place within the vacuum chamber 44 during the refilling process. While the universally shaped vacuum chamber 44 is beneficially able to accommodate a wide variety of different ink-jet cartridges, more specifically shaped vacuum chambers 44 may be easier to use, as a particular type of cartridge 12 is quickly and easily placed into and taken out of the chamber 44, before and after refilling respectively.

A vacuum may be created in the vacuum chamber 44 by evacuating air from the chamber 44 utilizing a vacuum pump 46, as shown in FIG. 1. Alternatively, a vacuum may be generated by directing a large volume of compressed air through a vacuum generator 46, also known as a venturi valve, as shown in FIG. 3.

The claimed process can advantageously utilize a number of different ink filling pathways 20. For cartridges 12 containing a single color of ink 16, only one ink filling pathway 20 is required. Multiple ink filling pathways 20 may be used to fill multiple ink reservoirs 66 with different colors of ink 16, as shown in FIGS. 3 and 4. An ink filling pathway 20 may advantageously consist of a syringe 42 connected to a hollow tube or hose 34, which hose 34 is connected at an opposite end to a hollow needle 28, as shown in FIG. 3. Alternatively, an ink filling pathway 20 may consist of a hollow tube or hose 34, as shown in FIGS. 1 and 2, connected at one end to a pump 38 and at an opposite end to a hollow needle 28. The hollow needle 28 is inserted into the cartridge 12, so that a print head end 30 of the needle 28 is positioned within the cartridge 12 in proximity to the print head 14, while the opposite end 32 of the needle 28 is attached to the hose 34. In this manner, ink 16 may be beneficially pumped through the hollow tube 34 and into the needle 28, pushing the ink 16 into the cartridge 12 so that ink is deposited near the print head 14. When multiple ink filling pathways 20 are used to fill multiple reservoirs 66, each needle 28 can advantageously be inserted into a separate reservoir 66.

As shown in FIG. 1, a flow restriction valve 36 may be placed along the hollow tube 34 to prevent ink 16 from migrating backwards from the cartridge 14. This valve 36 is ideally rated for 12-20 pounds per square inch, and prevents ink 16 from moving toward the cartridge 12 until a desired pressure is applied to ink 16 in the ink flowing pathway 20. In this manner, a pressure differential between atmospheric conditions outside the vacuum chamber 44 and vacuum conditions inside the chamber 44 will not be sufficient to cause ink 16 to flow toward the cartridge 12, but ink 16 will be forced through the valve 36 and into the cartridge 12 when the pumping means 18 is engaged. A number of mechanisms can be beneficially used as the ink pumping means 18. For example, as illustrated in FIG. 1, the ink pumping means 18 may be one or more peristaltic pumps. The pump driver (not shown) that drives the piston in the pump cylinder can either be a pneumatic air cylinder ideally set between 30 and 60 pounds per square inch or a mechanical means such as a motor driven screw through a fixed nut. When a pneumatic air cylinder is used, the ink injection flow rate is controlled by controlling the air flow rate at the air exit outlet of the pneumatic cylinder with a needle air valve. Alternatively, the pumping means 18 may consist of a volumetric dosage syringe 42 with a plunger, as shown in FIG. 5, which mechanically squirts ink 16 through the syringe 42 directly into the cartridge 12 (not shown), or into a hose 34 and/or needle 28 inserted into the cartridge 42. In this embodiment, as shown in FIG. 3, solenoid valves 70 may advantageously control the directional flow of ink 16 through the ink pathway 20. As the syringe 42 plunger retracts, ink 16 is drawn from an ink supply (not shown) through the valve 70 and into the syringe barrel. Then, when the plunger piston advances, the valve 70 shifts, blocking passage to the supply line and directing the flow of ink 16 from the syringe barrel down the filling pathway 20 and into the cartridge 12. Each syringe 42 is driven by a linear actuator which may be pneumatic, mechanical, or electrical. Ink 16 can conveniently be pumped or injected into the cartridge 12 through the ink flowing pathway 20 at a flow rate of 0.5 to 2 cc per second through either type of pathway 20.

The vacuum chamber 44 can beneficially consist of a cast aluminum box capable of withstanding vacuum conditions up to 29.9 inches Hg. As shown in FIG. 2, a seal 60 makes the vacuum chamber 44 air tight when the door 58 is closed. A variety of different common latches 62 can be utilized to securely hold the chamber door 58 in a closed position. When the cartridge 12 has been properly positioned within the chamber 44, a vacuum pump 46 may advantageously be used to remove air from the vacuum chamber 44, ideally creating a vacuum of between 18 and 25 inches Hg. Pressure within the vacuum chamber 44 and lines leading from the vacuum chamber 44 to the vacuum pump 46 can be beneficially monitored by a vacuum gauge 74. When a desired pressure is reached, a manual valve 76 may be utilized to discontinue vacuum generation, as shown in FIG. 3. Alternatively, as shown in FIG. 1, a vacuum pressure switch 68 may monitor vacuum pressure, sending an electrical signal to a solenoid valve 72 to divert vacuum generation to a bypass when the vacuum reaches a preset threshold.

It is critically important that the device 10 include a vacuum releasing means 24 to restore atmospheric pressure within the vacuum chamber 44 and the cartridge 12 while ink 16 is being pumped into the cartridge 12. At a desired time, which can advantageously be within 2 to 5 seconds after initiation of filling the cartridge 12 with ink 16, the vacuum releasing means 24 is activated to infuse air into the vacuum chamber 44. The vacuum releasing means 24 can conveniently be a timer 52 which actuates an air infusion means 48 at a desired time during the filling process. The air infusion means 48 can simply be a vacuum relief valve 50, as shown in FIG. 1, which is opened when the timer 52 indicates the passage of the desired time, filling the vacuum chamber 44 with air.

This process causes ink 16 to flow and rapidly fill the print head 14 and/or ink reservoir 66 while the cartridge 12 is under a vacuum, priming the print head 14 for use. At the same time, rapid infusion of air into the vacuum chamber 44 through the vacuum relief valve 50 restores atmospheric pressure in the cartridge 12, keeping ink 16 from migrating to the top of the foam 64, while allowing the foam 64 to be completely filled starting from the bottom and moving upward without overflowing through the top of the foam 64. Because the vacuum is released prior to completely filling the cartridge 12, the claimed process avoids ink 16 being sucked out of the cartridge 12 when the cartridge 12 is returned to atmospheric pressure.

Although the present invention has been described in terms of the presently preferred embodiment, it is to be understood that such disclosure is purely illustrative and is not to be interpreted as limiting. Consequently, without departing from the spirit and scope of the invention, various alterations, modifications, or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

What is claimed is:

1. A device for filling an ink-jet cartridge with ink, comprising:
a. ink pumping means,
b. ink filling pathway leading from ink pumping means into the cartridge,
c. vacuum creating means for removing air from cartridge, and
d. timed vacuum releasing means for infusing air into the cartridge at a selected time while ink is being pumped into the cartridge.

2. A device according to claim 1, further comprising:
e. print head closure means for sealing a print head of the cartridge to prevent air from migrating towards the print head when air is removed from the cartridge.

3. A device according to claim 1, wherein said ink filling pathway further comprises:
a. a hollow needle inserted into the cartridge, with a print head end of the needle positioned inside the cartridge in proximity to the print head, and
b. a hollow tube connected to an end of the needle opposite the print head end, said hollow tube providing a pathway for ink between the needle and the ink pumping means.

4. A device according to claim 3, wherein said ink filling pathway further comprises:
c. a flow restriction valve preventing ink from flowing along said ink filling pathway when pressure applied to said flow restriction valve is less than a desired flow pressure.

5. A device according to claim 4, wherein said flow restriction valve prevents ink from flowing out of the cartridge, while permitting ink to flow into the cartridge when pressure above said desired flow pressure is applied to ink in said ink filling pathway.

6. A device according to claim 4, wherein said flow restriction valve is positioned between said hollow tube and said hollow needle.

7. A device according to claim 4, wherein said flow restriction valve is connected to said hollow tube in proximity to said hollow needle.

8. A device according to claim 1, wherein said ink pumping means comprises a peristaltic pump pumping ink through said ink filling pathway.

9. A device according to claim 1, wherein said ink pumping means comprises a syringe for injecting ink through the ink filling pathway.

10. A device according to claim 1, wherein said vacuum creating means comprises a vacuum chamber in which the cartridge and a portion of said ink filling pathway are held, from which air is removed by a vacuum pump.

11. A device according to claim 10, wherein said vacuum pump removes air from said vacuum chamber to create a vacuum between 18 inches Hg and 25 inches Hg.

12. A device according to claim 10, wherein said vacuum chamber is sized to permit cartridges of differing sizes to be held within said chamber.

13. A device according to claim 10, wherein said vacuum chamber is sized to permit a cartridge of particular dimensions to be held within said chamber.

14. A device according to claim 10, wherein said vacuum chamber is constructed of cast aluminum.

15. A device according to claim 10, wherein said timed vacuum releasing means comprises an air infusion means for infusing air into said vacuum chamber, while said ink pumping means is pumping ink through said ink filling pathway into the cartridge.

16. A device according to claim 15, wherein said air infusion means comprises a vacuum relief valve for opening said vacuum chamber to an area of atmospheric pressure to allow air to enter said vacuum chamber.

17. A device according to claim 15, further comprising a timer to actuate air infusion means at said selected time after ink pumping means begins to pump ink through said ink filling pathway into the cartridge.

18. A device according to claim 1, wherein said selected time is not less than two seconds and not greater than 5 seconds after said ink pumping means begins to pump ink into the cartridge.

19. A method for filling an ink-jet cartridge with ink, comprising the steps of:
a. removing air from the cartridge to create a vacuum,
b. pumping ink through an ink filling pathway leading into the cartridge, and
c. releasing said vacuum by infusing air into the cartridge at a selected time while ink is being pumped into the cartridge.
